(19) United States
(12) Patent Application Publication
(10) Pub. No.: US 2026/0290055 A1
(43) Pub. Date: Sep. 24, 2026

(54) INFORMATION PROCESSING APPARATUS, INFORMATION PROCESSING SYSTEM, INFORMATION PROCESSING METHOD, AND NON-TRANSITORY COMPUTER READABLE MEDIUM

(71) Applicant: NEC Corporation, Tokyo (JP)

(72) Inventors: Kazumine OGURA, Tokyo (JP); Takami SATO, Tokyo (JP); Yuya MATSUMOTO, Tokyo (JP); Hiromi OKADA, Tokyo (JP); Kyousei YAMAMOTO, Tokyo (JP)

(73) Assignee: NEC Corporation, Tokyo (JP)

(21) Appl. No.: 19/557,394

(22) Filed: Mar. 5, 2026

(30) Foreign Application Priority Data
Mar. 18, 2025 (JP) 2025-044010

(51) Int. Cl. G06V 20/70; G06T 7/73; G06T 7/80; G06V 20/50

(52) U.S. Cl. CPC G06V 20/70; G06T 7/74; G06T 7/80; G06V 20/50; G06T 2207/10028; G06T 2207/30236

(57) ABSTRACT

An information processing device includes a target selection unit, a reference plane specifying unit, a position specifying unit, and a label generation unit. The target selection unit selects a representative part of an assignment target to which a label is to be assigned, from a captured image obtained by imaging a target area. The reference plane specifying unit specifies a position of a reference plane in the target area, based on the three-dimensional information obtained by observing the target area. The position specifying unit specifies a label position indicating a three-dimensional position of the label to be assigned to the assignment target, based on a position obtained by projecting the representative part onto the reference plane. The label generation unit generates label information including the label position.

This application is based upon and claims the benefit of priority from Japanese patent application No. 2005-44010, filed on Mar. 18, 2025, the disclosure of which is incorporated herein in its entirety by reference.

### TECHNICAL FIELD

The present invention relates to an information processing apparatus, an information processing system, an information processing method, and a non-transitory computer readable medium.

### BACKGROUND ART

For example, JP 2023-167539 A discloses an environmental data generation device including a point cloud data acquisition unit, an image data acquisition unit, and an environmental data generation unit.

The point cloud data acquisition unit acquires point cloud data output from a distance measurement device. The distance measurement device irradiates a plurality of measurement points in a space of a construction environment with light, receives reflected light obtained by the light being reflected from an object existing in the construction environment, and outputs point cloud data representing distances between the plurality of measurement points and the object, based on the reflected light.

The image data acquisition unit acquires image data from a camera for imaging an area of the construction environment including an area measured by the distance measurement device.

In a case where an object recognized by performing an object recognition process based on the point cloud data and an object recognized by performing an object recognition process based on the image data are objects in a correspondence relationship, the environmental data generation unit generates environmental data in which a label representing the objects in a correspondence relationship is added to a topographical map obtained from the point cloud data.

In a case where a direction and a distance with respect to the object recognized based on a first function and a direction and a distance with respect to the object recognized based on a second function are the same or within a certain range, respectively, the environmental data generation unit assigns an attribute based on the image data, as a label, to the topographical map based on the point cloud data.

The first function is a function of recognizing an object based on point cloud data. The second function is a function of recognizing an object based on image data.

### SUMMARY

However, in general, in a case where an object is recognized from point cloud data, the recognition accuracy for the object is often low. In a case where an object is recognized from image data, the positional accuracy for the object is often low. For this reason, in the technique described in JP 2023-167539 A, for example, there is a possibility that a three-dimensional label may not be assigned at an appropriate position of the object recognized from the point cloud data.

One subject matter of this disclosure is to assign, for an object included in three-dimensional information, a three-dimensional label indicating the object at an appropriate position.

An information processing device according to one aspect of the present disclosure includes

a target selection means for selecting a representative part of an assignment target to which a label is to be assigned, from a captured image obtained by imaging a target area,

a reference plane specifying means for specifying a position of a reference plane in the target area, based on three-dimensional information obtained by observing the target area,

a label position specifying means for specifying a label position indicating a three-dimensional position of the label to be assigned to the assignment target, based on a position obtained by projecting the representative part onto the reference plane, and

a label generation means for generating label information including the label position.

An information processing system according to one aspect of the present disclosure includes

the information processing device,

an imaging device that captures the captured image of the target area, and

a three-dimensional observation device that observes the target area to acquire the three-dimensional information.

An information processing method according to one aspect of the present disclosure includes,

by one or more computers,

selecting a representative part of an assignment target to which a label is to be assigned, from a captured image obtained by imaging a target area,

specifying a position of a reference plane in the target area, based on three-dimensional information obtained by observing the target area,

specifying a label position indicating a three-dimensional position of the label to be assigned to the assignment target, based on a position obtained by projecting the representative part onto the reference plane, and

generating label information including the label position.

A program according to one aspect of the present disclosure is a program for causing

one or more computers to execute

selecting a representative part of an assignment target to which a label is to be assigned, from a captured image obtained by imaging a target area,

specifying a position of a reference plane in the target area, based on three-dimensional information obtained by observing the target area,

specifying a label position indicating a three-dimensional position of the label to be assigned to the assignment target, based on a position obtained by projecting the representative part onto the reference plane, and

generating label information including the label position.

As an example advantage of the present disclosure, for an object included in three-dimensional information, a label indicating the object can be assigned at an appropriate position.

### BRIEF DESCRIPTION OF THE DRAWINGS

FIG. 1 It is a block diagram illustrating a configuration example of a first information processing system according to the present disclosure;

FIG. 2 It is a block diagram illustrating a configuration example of a first information processing device according to the present disclosure;

FIG. 3 It is a flowchart illustrating a processing operation example of the first information processing device according to the present disclosure;

FIG. 4 It is a block diagram illustrating a detailed configuration example of the first information processing system according to the present disclosure;

FIG. 5 It is a diagram illustrating an example of a method for specifying a label position according to the present disclosure;

FIG. 6 It is a diagram illustrating an example of size definition information according to the present disclosure;

FIG. 7 It is a diagram illustrating an example of label information according to the present disclosure;

FIG. 8 It is a block diagram illustrating a physical configuration example of the first information processing device according to the present disclosure;

FIG. 9 It is a block diagram illustrating a configuration example of a second information processing device according to the present disclosure; and

FIG. 10 It is a flowchart illustrating a processing operation example of the second information processing device according to the present disclosure.

### EXAMPLE EMBODIMENT

Hereinafter, in the present disclosure, the drawings are associated with one or more example embodiments. In all the drawings, similar components are denoted by similar reference signs, and description thereof will be omitted as appropriate.

### FIRST EXAMPLE EMBODIMENT

### (Overview)

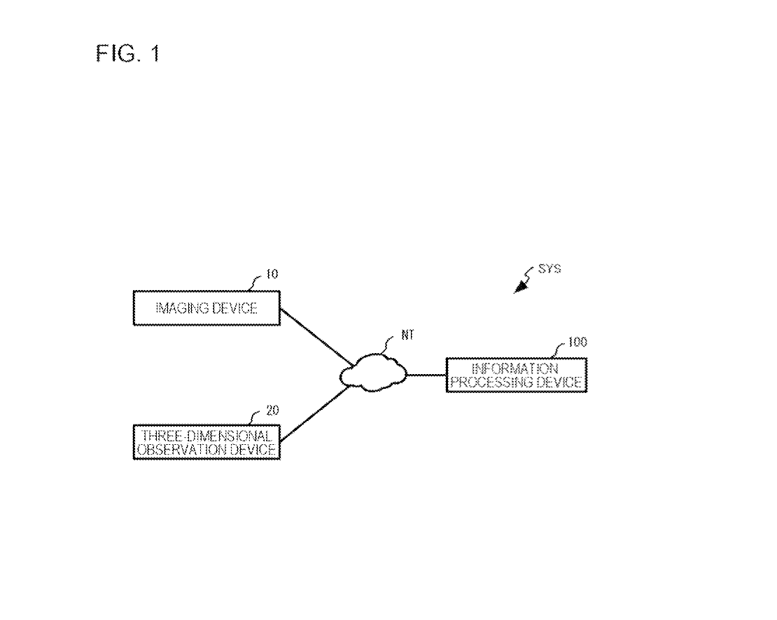

As illustrated in FIG. 1, an information processing system SYS includes an imaging device 10 that captures a captured image of a target area, a three-dimensional observation device 20 that observes the target area to acquire three-dimensional information, and an information processing device 100.

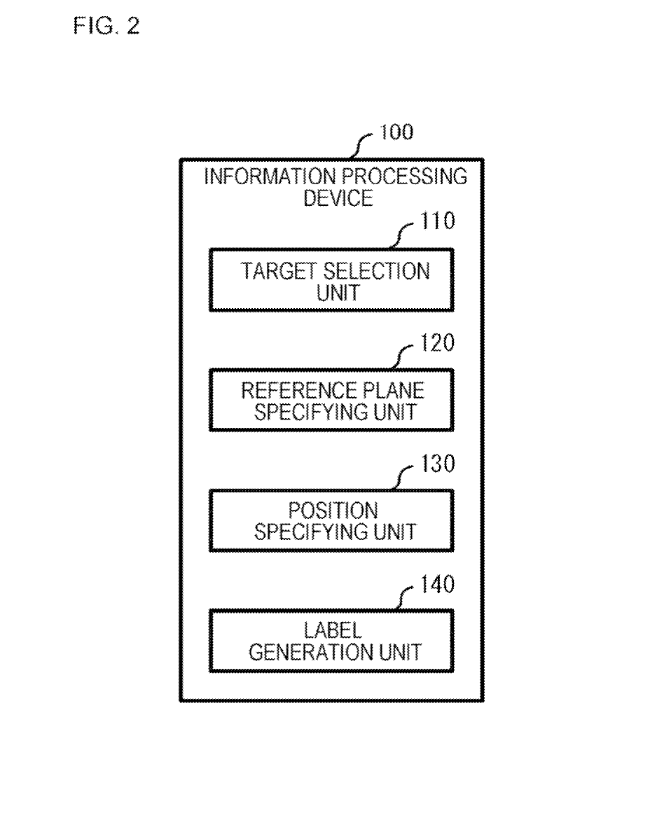

As illustrated in FIG. 2, the information processing device 100 includes a target selection unit 110, a reference plane specifying unit 120, a position specifying unit 130, and a label generation unit 140.

The target selection unit 110 selects a representative part of an assignment target to which a label is to be assigned, from a captured image obtained by imaging a target area.

The reference plane specifying unit 120 specifies a position of a reference plane in the target area, based on three-dimensional information obtained by observing the target area.

The position specifying unit 130 specifies a label position indicating a three-dimensional position of the label to be assigned to the assignment target, based on a position obtained by projecting the representative part onto the reference plane.

The label generation unit 140 generates label information including the label position.

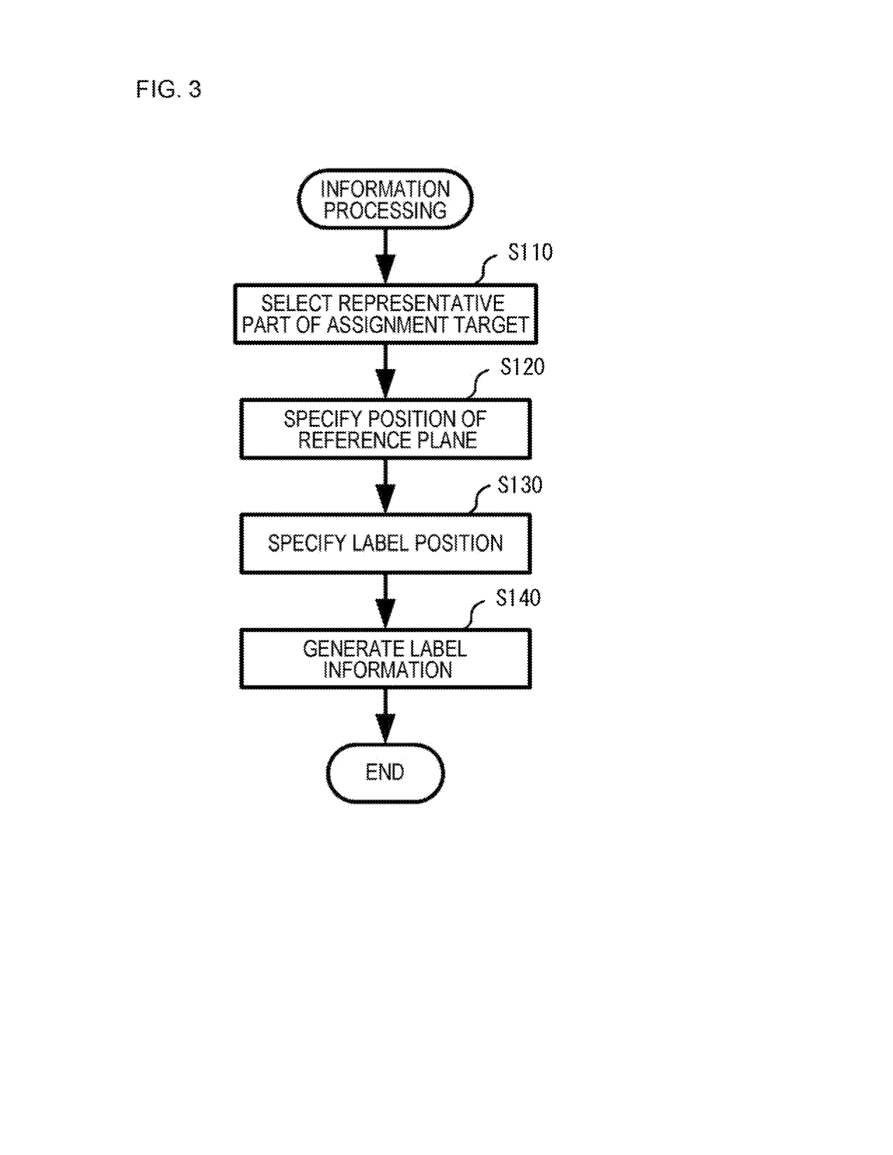

The information processing device 100 executes information processing as illustrated in the flowchart in FIG. 3.

The target selection unit 110 selects a representative part of an assignment target to which a label is to be assigned, from a captured image obtained by imaging the target area (step S110).

The reference plane specifying unit 120 specifies a position of a reference plane in the target area, based on three-dimensional information obtained by observing the target area (step S120).

The position specifying unit 130 specifies a label position indicating a three-dimensional position of the label to be assigned to the assignment target, based on a position obtained by projecting the representative part onto the reference plane (step S130).

The label generation unit 140 generates label information including the label position (step S140).

According to each of the information processing system SYS, the information processing device 100, and the information processing, since the label position is specified based on the position obtained by projecting the representative part onto the reference plane, the label position can be specified without using the position of the object estimated from the captured image. Therefore, for an object included in three-dimensional information, a three-dimensional label indicating the object can be assigned at an appropriate position.

Hereinafter, a detailed example of the information processing system SYS will be described.

### (Detailed Example)

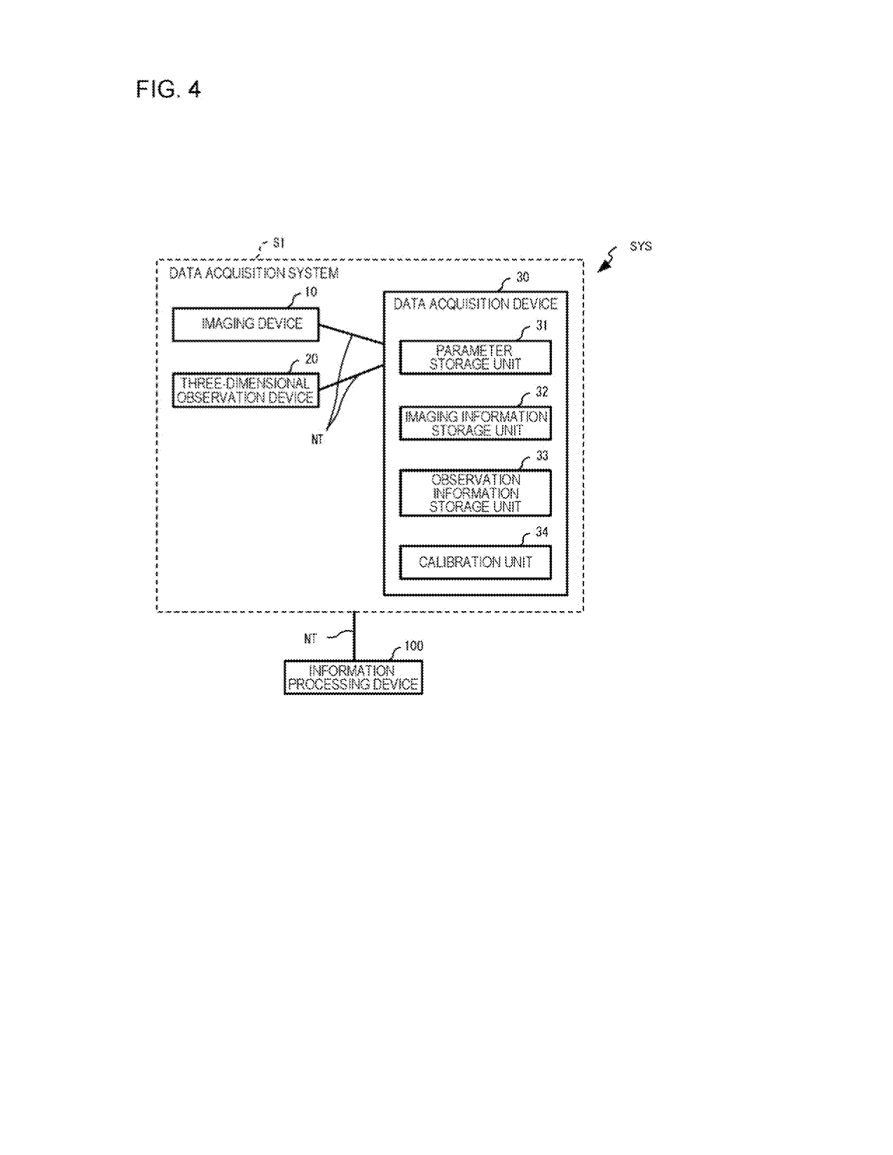

The information processing system SYS is a system for assigning a three-dimensional label, based on a captured image obtained by imaging a target area and three-dimensional information obtained by observing the target area. As illustrated in FIG. 4, the information processing system SYS includes a data acquisition system S1 and the information processing device 100.

The data acquisition system S1 and the information processing device 100 are connected to each other via a communication network NT, for example, and transmit and receive information, data, and the like to and from each other via the communication network NT. The communication network NT is a network used for communication and is configured in a wired manner, a wireless manner, or a combination thereof.

### (Data Acquisition System S1)

The data acquisition system S1 includes the imaging device 10, the three-dimensional observation device 20, and a data acquisition device 30.

Each of the imaging device 10 and the three-dimensional observation device 20, and the data acquisition device 30 are connected to each other via the communication network NT, for example, and transmit and receive information, data, and the like to and from each other via the communication network NT.

A plurality of the imaging devices 10 may be provided. A plurality of the three-dimensional observation devices 20 may be provided.

### (Imaging Device 10)

The imaging device 10 captures a two-dimensional captured image indicating the target area. The imaging device 10 is, for example, a fixed camera or the like. Examples of the camera include a visible light camera, an infrared camera, and an event camera. For example, the imaging device 10 may continuously capture captured images to capture time-series captured images.

### (Three-Dimensional Observation Device 20)

The three-dimensional observation device 20 is related to, for example, light detection and ranging (LiDAR). For example, the three-dimensional observation device 20 acquires point cloud data, based on the reflected light of light with which the target area is irradiated. The three-dimensional observation device 20 may acquire time-series point cloud data, for example, by continuously observing the target area.

The three-dimensional information is information including a distance to an object existing at a plurality of measurement points in the target area. The three-dimensional information acquired using LiDAR is also referred to as point cloud data or the like.

The three-dimensional observation device 20 is not limited to LiDAR and may be related to, for example, radio detection and ranging (RADAR) or the like that acquires three-dimensional information using radio waves. The three-dimensional information acquired using LiDAR is also referred to as voxel data or the like.

### (Target Area and Assignment Target)

The area imaged by the imaging device 10 and the area observed by the three-dimensional observation device 20 include the same target area.

The target area is, for example, an area including a road. In this case, the imaging device 10 and the three-dimensional observation device 20 are fixedly installed along the road, for example. The captured image and the three-dimensional information in this case include, for example, an object such as an automobile, a person, a motorcycle, or a bicycle passing through the road. This object is selected as an assignment target.

The target area is not limited to an area including a road. The type of the assignment target is not limited to an automobile, a person, a motorcycle, and a bicycle.

### (Data Acquisition Device 30)

The data acquisition device 30 is an information processing device for acquiring the captured image and the three-dimensional information. The data acquisition device 30 functionally includes, for example, a parameter storage unit 31, an imaging information storage unit 32, an observation information storage unit 33, and a calibration unit 34.

The parameter storage unit 31 is a storage unit for storing parameters including at least one of a calibration parameter, an imaging parameter, and a three-dimensional observation parameter. These parameters are stored in advance in the parameter storage unit 31, for example.

The calibration parameter is a parameter for calibrating the captured image and the three-dimensional information.

The calibration parameter may include, for example, a value indicating magnitude of deviation in relevant positions and directions between the captured image and the three-dimensional information. The calibration parameter may include, for example, a value for calibrating a position or a direction in at least one of the captured image and the three-dimensional information.

The imaging parameter is an internal parameter of the imaging device 10 that captures the captured image.

The imaging parameter may include, for example, at least one of a device identification (ID) for identifying the imaging device 10, a position (imaging position) where the imaging device 10 is installed, and a direction or range (imaging direction) in which the imaging device 10 performs imaging.

The three-dimensional observation parameter is an internal parameter of the three-dimensional observation device 20 that observes three-dimensional information.

The three-dimensional observation parameter may include, for example, at least one of a device ID for identifying the three-dimensional observation device 20, a position (observation position) where the three-dimensional observation device 20 is installed, and a direction or a range (observation direction) in which the three-dimensional observation device 20 radiates light or the like.

The position may be represented using, for example, latitude, longitude, and altitude. Instead of altitude, a height with reference to the road surface may be used. The direction may be represented using, for example, compass bearings.

As the position and direction in the captured image, for example, coordinate position and direction in a two-dimensional coordinate system for representing each pixel may be used. The three-dimensional position and direction may be represented using, for example, coordinate position and direction in a coordinate system used to represent the three-dimensional information.

The imaging information storage unit 32 is a storage unit for storing imaging information including the captured image. The imaging information may further include a device ID of the imaging device 10, an imaging date and time indicating a date and time of imaging, and the like.

The observation information storage unit 33 is a storage unit for storing observation information including the three-dimensional information. The observation information may further include a device ID of the three-dimensional observation device 20, an observation date and time indicating a date and time of observation, and the like.

Upon acquiring the captured image from the imaging device 10, the calibration unit 34 generates the imaging information by performing calibration using the parameters and stores the generated imaging information in the imaging information storage unit 32. Upon acquiring the three-dimensional information from the three-dimensional observation device 20, the calibration unit 34 generates the observation information by performing calibration using the parameters and stores the generated observation information in the observation information storage unit 33.

As described above, in the data acquisition system S1, the data acquisition device 30 calibrates the captured image and the three-dimensional information and stores the calibrated captured image and three-dimensional information in the imaging information storage unit 32 and the observation information storage unit 33, respectively.

Some or all of the functions included in the data acquisition device 30 may be included in the information processing device 100.

### (Information Processing Device 100)

As described above, the information processing device 100 includes the target selection unit 110, the reference plane specifying unit 120, the position specifying unit 130, and the label generation unit 140 (see FIG. 2). Detailed examples of these units will be described below.

### (Target Selection Unit 110)

The target selection unit 110 acquires, for example, the imaging information stored in the imaging information storage unit 32 from the data acquisition device 30. The target selection unit 110 selects a representative part of an assignment target to which a label is to be assigned, from, for example, the captured image included in imaging information. The target selection unit 110 may further select the type of the assignment target.

### (First Example of Selection Method)

For example, the target selection unit 110 may select a pixel designated by a user on the captured image, as a representative part. For example, the user designates a point in the assignment target included in the captured image on a screen on which the captured image is displayed. The target selection unit 110 may select a pixel relevant to the designated point, as a representative part.

The selected representative part is desirably close to the reference plane. In a case where the reference plane is, for example, a road surface of a road, the user desirably designates points such as a license plate of an automobile, a lower foot part of a person, and a lower portion (for example, a portion in contact with the road) of tires of a motorcycle and a bicycle, for example.

For example, the target selection unit 110 may select the type of the assignment target, based on an instruction from the user. The type of the assignment target may include, for example, at least one of an automobile, a person, a motorcycle, a bicycle, and the like.

### (Second Example of Selection Method)

For example, the target selection unit 110 may estimate the position and the type of an object included in the captured image and select the estimated object as an assignment target.

For example, the target selection unit 110 may estimate the type and the position of the object, using an object detection model for detecting an object from the captured image. Then, the target selection unit 110 may select the position of the representative part of the assignment target and the type of the assignment target, based on the estimated type and position of the object.

In a case where the captured image includes a plurality of objects, the target selection unit 110 may sequentially select the position and the type of the representative part with each object as an assignment target.

The object detection model is, for example, a trained machine learning model for detecting an object from the captured image. For example, in response to an input of the captured image, the object detection model detects an object included in the captured image and outputs a position and a type of the detected object.

The object detection model may be constructed by performing training using training data including a captured image for training and a ground truth label of an object included in the captured image. In this training, the object detection model may be trained in such a way as to detect, for example, a position close to the reference plane as the position of the object. For example, the position close to the reference plane is a license plate of an automobile, a lower foot part of a person, a lower portion of tires of a motorcycle and a bicycle, and the like in a case where the reference plane is a road surface. The type of the object to be detected may be predefined.

The method for estimating the type and the position of the object from the captured image is not limited to those exemplified here, and a known technique may be applied.

### (Reference Plane Specifying Unit 120)

The reference plane specifying unit 120 acquires, for example, the observation information stored in the observation information storage unit 33 from the data acquisition device 30. The reference plane specifying unit 120 specifies the position of the reference plane in the target area, based on, for example, the three-dimensional information included in the observation information.

The reference plane is, for example, a plane whose position is fixed in the target area. In a case where the target area includes a road, the reference plane may be, for example, a road surface. The reference plane specifying unit 120 may acquire observation information including a plurality of pieces of three-dimensional information observed at different observation times, for example, time-series observation information. Then, for example, the reference plane specifying unit 120 may specify a plane whose position is fixed, based on the plurality of pieces of three-dimensional information, to specify the position of the road surface as the reference plane.

### (Position Specifying Unit 130)

As described above, the position specifying unit 130 specifies a label position indicating a three-dimensional position of the label to be assigned to the assignment target, based on a position obtained by projecting the representative part onto the reference plane.

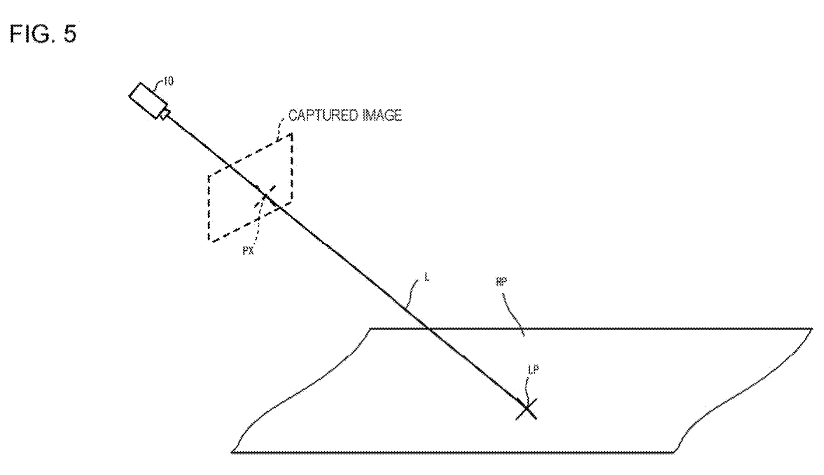

FIG. 5 is a diagram illustrating an example of a method for specifying a label position LP, based on the position obtained by projecting the representative part onto a reference plane RP. As illustrated in FIG. 5, the direction in which the representative part is projected onto the reference plane RP may be, for example, an imaging direction of the representative part, in detail, for example, a light ray direction for capturing a pixel PX relevant to the representative part. The light ray direction is represented by, for example, a direction in a three-dimensional space representing a measurement point included in the three-dimensional information.

For example, the position obtained by projecting the representative part onto the reference plane may be an intersection of a straight line L three-dimensionally representing a light ray for capturing the pixel PX relevant to the representative part in the captured image, and the reference plane RP. This intersection may be specified as the label position LP.

The label position is relevant to a predefined position of the three-dimensional label. For example, in a case where the label is a cube, the label position may be a position of one of eight corners that the label has, for example, one of four corners located at the bottom. For example, in a case where the label is a cube, the label position may be the center of one of 12 sides that the label has, for example, one of the four sides located at the bottom.

Here, as described above, the captured image and the three-dimensional information have been calibrated using the calibration parameter, the imaging parameter, and the three-dimensional observation parameter in the data acquisition device 30. Therefore, the position obtained by projecting the representative part onto the reference plane is calculated using at least one of the calibration parameter, the imaging parameter, and the three-dimensional observation parameter.

One or both of the captured image and the three-dimensional information may not be calibrated in the data acquisition device 30. In this case, the position specifying unit 130 may acquire the parameters stored in the parameter storage unit 31 from the data acquisition device 30. Then, the position specifying unit 130 may calibrate one or both of the captured image and the three-dimensional information, using the acquired parameters, to calculate the position obtained by projecting the representative part onto the reference plane. As a result, the position obtained by projecting the representative part onto the reference plane may be calculated using at least one of the calibration parameter, the imaging parameter, and the three-dimensional observation parameter.

The position specifying unit 130 may specify the label position by correcting the position obtained by projecting the representative part onto the reference plane by a predetermined method. For example, in a case where the selected representative part is, for example, far from the road surface or the like that is the reference plane, the projected position may be corrected according to a distance between a selected specified part and a predefined reference point, and the corrected position may be specified as the label position.

For example, the reference point may be predefined for each type of object. The reference point is, for example, a license plate of an automobile, a lower foot part of a person, a lower portion of a tire of a motorcycle or a bicycle, or the like. The position specifying unit 130 may correct the projected position, according to a distance between the position of the reference point according to the selected assignment target and the selected specified part, and specify the corrected position as the label position. In a case where the above distance is larger than a predefined threshold value, the position specifying unit 130 may correct the projected position, according to the distance, and specify the corrected position as the label position.

The position of the reference point may be designated by the user, or for example, may be estimated by the position specifying unit 130 using a trained object detection model. The object detection model is a machine learning model that outputs the type of the object and the position of the reference point in the captured image in response to an input of the captured image.

With this correction, for example, even in a case where the user designates, as the specified part, a pixel far from the reference plane in the area indicating the assignment target in the captured image, the three-dimensional label of the assignment target can be assigned at an appropriate position.

### (Label Generation Unit 140)

The label generation unit 140 generates the label information on the assignment target. The label information includes, for example, the label position. This label position is, for example, a label position specified by the position specifying unit 130 and indicates a three-dimensional position.

The label information may further include, for example, a label size. The label size is information indicating a size of a three-dimensional area to which a label is to be assigned. For example, the label generation unit 140 may hold in advance size definition information that associates the type of the assignment target with the label size.

That is, the label size may be predefined according to the type of the assignment target. For example, the label size may be defined according to an average value of dimensions for each type of assignment target, but the predefined label size is not limited thereto.

Then, the label generation unit 140 may specify the label size according to the type of the assignment target and generate label information including the label position and the specified label size.

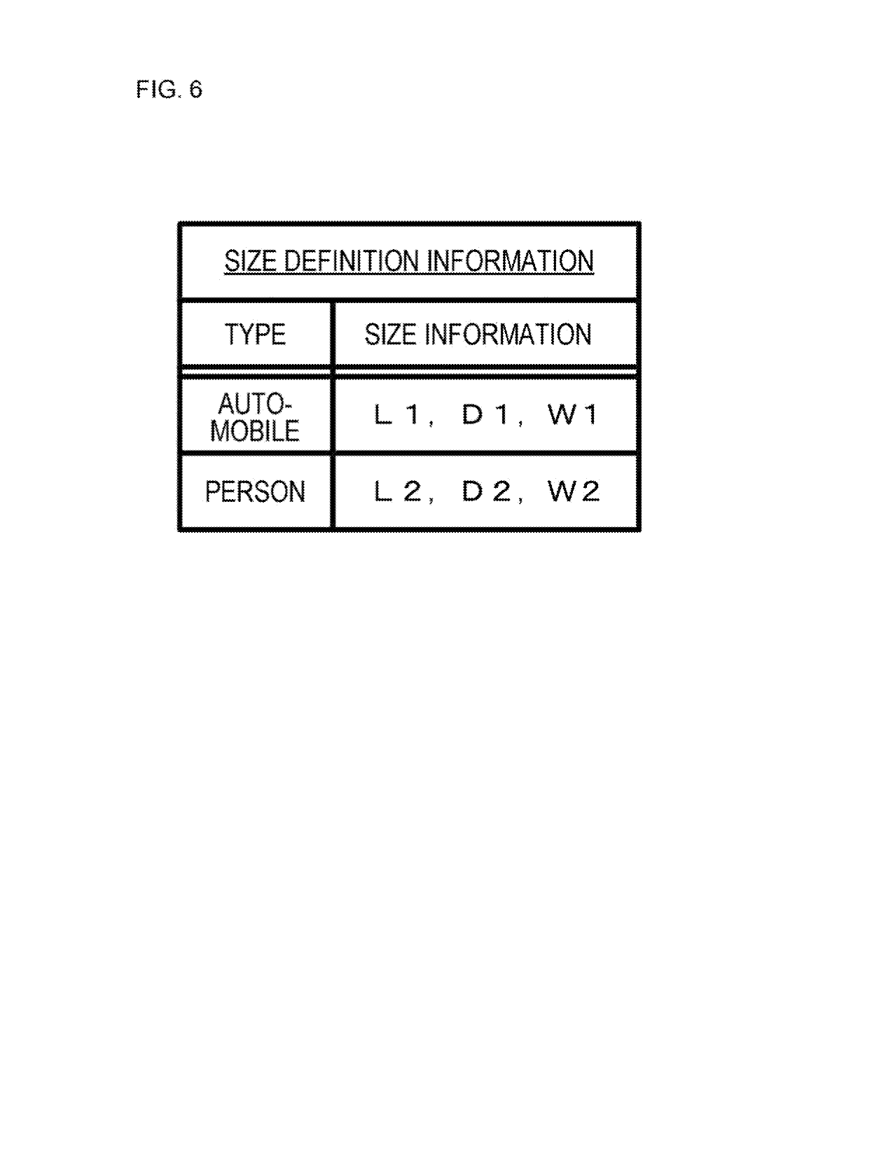

FIG. 6 is a diagram illustrating an example of the size definition information. The size definition information depicted in FIG. 6 includes a label size “L1, D1, W1” for the type of assignment target “automobile” and a label size “L2, D2, W2” for the type of assignment target “person”. The label is, for example, a rectangular parallelepiped, and L1 and L2 represent heights, D1 and D2 represent depths, and W1 and W2 represent widths. These dimensions may be represented by, for example, a length (millimeter) in the three-dimensional information, but are not limited thereto.

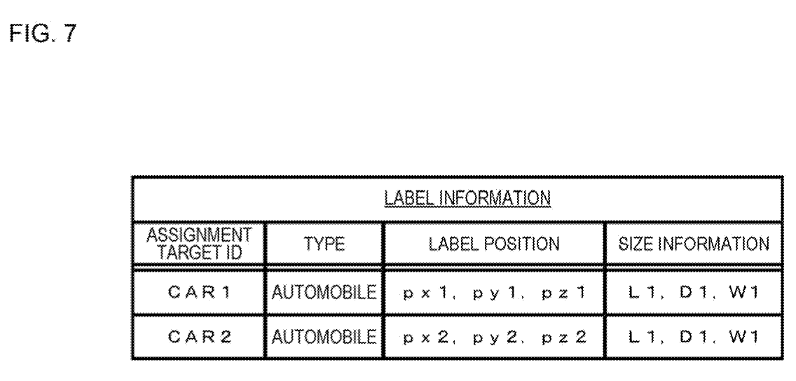

FIG. 7 is a diagram illustrating an example of the label information. In the label information depicted in FIG. 7, an assignment target ID, a type of assignment target, a label position, and a label size are associated with each other. The assignment target ID is information for identifying the assignment target.

FIG. 7 illustrates an example of label information in which a type “automobile”, a label position “px1, py1, pz1”, and a label size “L1, D1, W1” of an assignment target are associated with an assignment target ID “CAR1”. FIG. 7 further illustrates an example of label information in which a type “automobile”, a label position “px2, py2, pz2”, and a label size “L1, D1, W1” of an assignment target are associated with an assignment target ID “CAR2”.

For example, an image ID of the captured image used to generate the label information, the position of the selected specified part, and the like may be further associated with the assignment target ID.

The label generation unit 140 may output the generated label information. This output may include at least one of display on a display unit (not illustrated), storage in a storage unit (not illustrated), transmission to another device (not illustrated), and the like. In a case where the label information is transmitted to another device, the label information may be displayed or stored on the another device.

### (Physical Configuration Example of Information Processing Device 100)

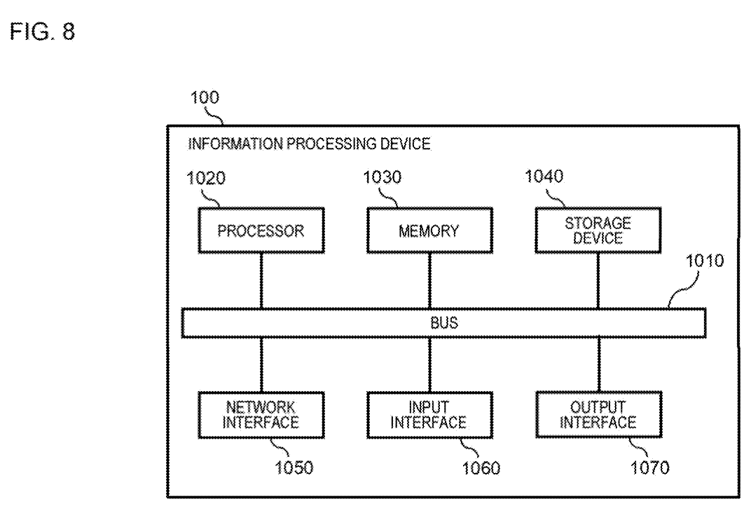

As illustrated in FIG. 8, for example, the information processing device 100 physically includes a bus 1010, a processor 1020, a memory 1030, a storage device 1040, a network interface 1050, an input interface 1060, and an output interface 1070.

The bus 1010 is a data transmission path through which the processor 1020, the memory 1030, the storage device 1040, the network interface 1050, the input interface 1060, and the output interface 1070 transmit and receive data to and from each other. However, the method for connecting the processor 1020 and other components to each other is not limited to the bus connection.

The processor 1020 is a processor implemented by a central processing unit (CPU), a graphics processing unit (GPU), or the like.

The memory 1030 is a main storage device implemented by a random access memory (RAM) or the like.

The storage device 1040 is an auxiliary storage device implemented by a hard disk drive (HDD), a solid state drive (SSD), a memory card, a read only memory (ROM), or the like. The storage device 1040 stores a program module for implementing functions of the information processing device 100. The processor 1020 reads these program modules into the memory 1030 to execute the read program modules, thereby implementing the functions relevant to the executed program modules.

The network interface 1050 is an interface for connecting the information processing device 100 to the communication network NT. Information may be transmitted to and received from another device (not illustrated) via the communication network NT.

The input interface 1060 is an interface for the user to input information and includes, for example, a touch panel, a keyboard, a mouse, and the like.

The output interface 1070 is an interface for presenting information to the user and includes, for example, a liquid crystal panel, an organic electro-luminescence (EL) panel, or the like. The output interface 1070 may also include a speaker.

Although an example in which the information processing device 100 is physically configured with one device (such as a computer, for example) has been described, the information processing device 100 may be configured with, for example, a plurality of devices (such as computers, for example) that transmit and receive information to and from each other via the communication network NT. In this case, the plurality of devices may execute information processing in cooperation. The data acquisition device 30 may be physically configured similarly to the information processing device 100, for example.

### (Operation and Effect)

As described above, according to the present example embodiment, the information processing device 100 includes the target selection unit 110, the reference plane specifying unit 120, the position specifying unit 130, and the label generation unit 140.

The target selection unit 110 selects a representative part of an assignment target to which a label is to be assigned, from a captured image obtained by imaging a target area. The reference plane specifying unit 120 specifies a position of a reference plane in the target area, based on three-dimensional information obtained by observing the target area. The position specifying unit 130 specifies a label position indicating a three-dimensional position of the label to be assigned to the assignment target, based on a position obtained by projecting the representative part onto the reference plane. The label generation unit 140 generates label information including the label position.

As a result, since the label position is specified based on the position obtained by projecting the representative part onto the reference plane, the label position can be specified without using the position of the object estimated from the captured image. Therefore, for an object included in three-dimensional information, a three-dimensional label indicating the object can be assigned at an appropriate position.

According to the present example embodiment, the reference plane is a road surface of a road. The position obtained by projecting the representative part onto the reference plane is an intersection of a straight line three-dimensionally representing a light ray for capturing a pixel relevant to the representative part in the captured image, and the road surface.

As a result, a label position of an object passing through the road can be specified with the road surface of the road as a reference plane. Therefore, for an object included in three-dimensional information obtained by observing the target area including the road, a three-dimensional label indicating the object can be assigned at an appropriate position.

According to the present example embodiment, the position obtained by projecting the representative part onto the reference plane is calculated using at least one of the calibration parameter for calibrating the captured image and the three-dimensional information, the imaging parameter that is an internal parameter of the imaging device that captures the captured image, and the three-dimensional observation parameter that is an internal parameter of the three-dimensional observation device that observes the three-dimensional information.

As a result, the positional relationship between the captured image and the three-dimensional information can be made to have relevance accurately. Therefore, for an object included in three-dimensional information, a three-dimensional label indicating the object can be assigned at an appropriate position.

According to the present example embodiment, the label information further includes a label size indicating a size of a three-dimensional area to which a label is to be assigned.

As a result, the captured image or the three-dimensional information to which the label is assigned can be displayed using the label information. Therefore, for an object included in the captured image or the three-dimensional information, an image in which a three-dimensional label indicating the object is assigned at an appropriate position can be displayed.

According to the present example embodiment, the label size is predefined according to the type of the assignment target.

As a result, labor for designating the label size and a process of determining the label size can be omitted. Therefore, a three-dimensional label having a size according to the type of an object included in the three-dimensional information can be easily assigned to the object.

According to the present example embodiment, the target selection unit 110 estimates the position and the type of an object included in the captured image and selects the estimated object as an assignment target.

As a result, the assignment target can be automatically selected. Therefore, the assignment target can be easily selected from objects included in the three-dimensional information.

### SECOND EXAMPLE EMBODIMENT

In the present example embodiment, an example in which the label size assigned to the assignment target is variable will be described. Note that description overlapping with other example embodiments will be omitted as appropriate for brevity of description.

An information processing system according to the present example embodiment includes an information processing device 200 instead of the information processing device 100 according to the first example embodiment. Except this point, the information processing system according to the present example embodiment may be configured similarly to the information processing system SYS according to the first example embodiment.

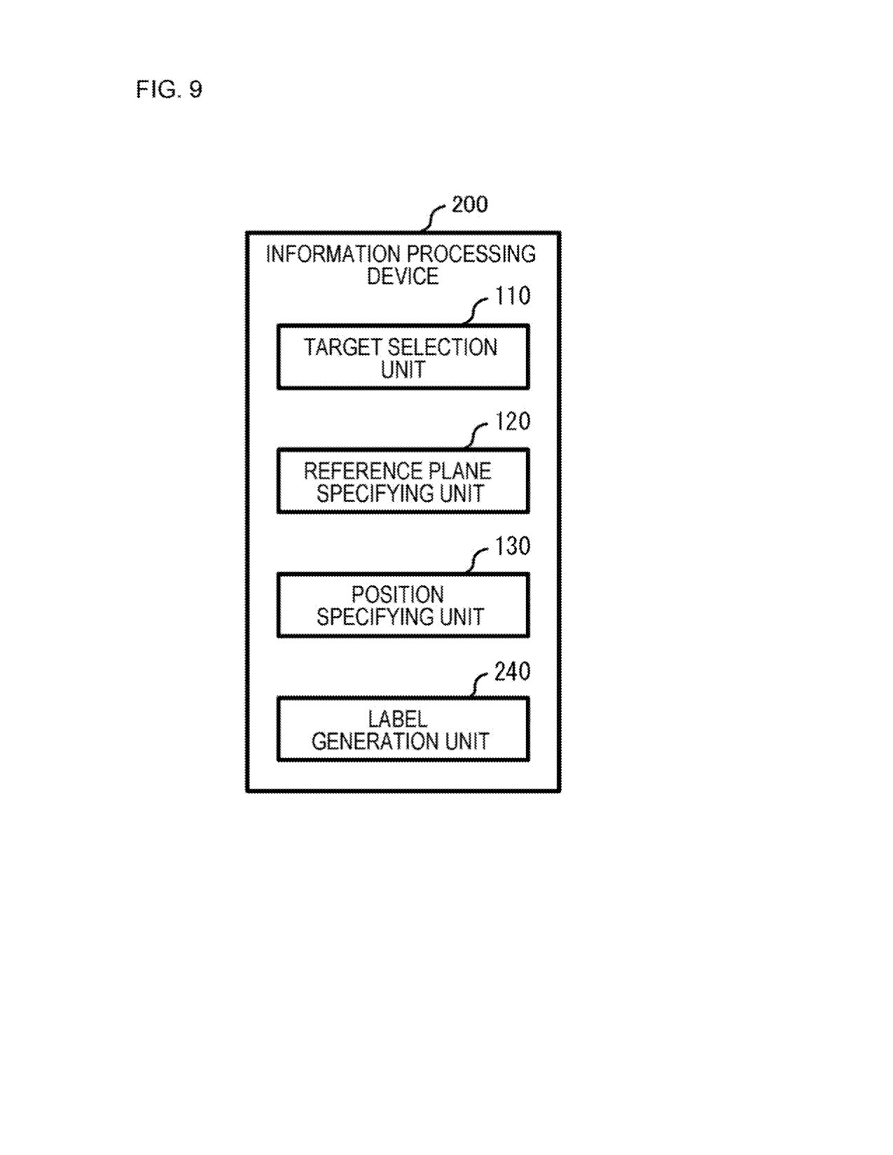

As illustrated in FIG. 9, the information processing device 200 includes a label generation unit 240 instead of the label generation unit 140 according to the first example embodiment. Except this point, the information processing device 200 according to the present example embodiment may be configured similarly to the information processing device 100 according to the first example embodiment.

The label generation unit 240 generates label information including a label position, similarly to the label generation unit 140 according to the first example embodiment.

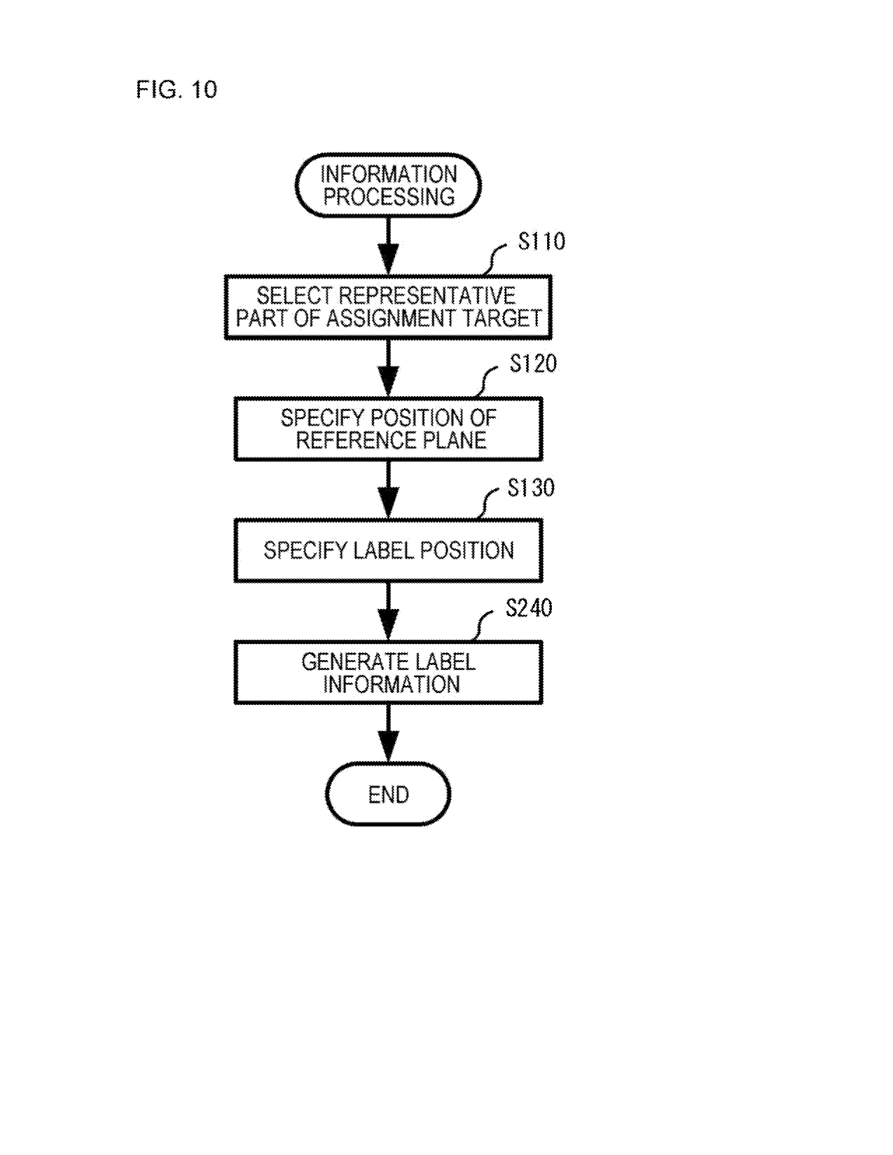

The information processing device 200 executes information processing as illustrated in the flowchart in FIG. 10. The information processing according to the present example embodiment includes a label information generation process (step S240) instead of the label information generation process (step S140) according to the first example embodiment. Except this point, the information processing according to the present example embodiment may be configured similarly to the information processing according to the first example embodiment.

The label generation unit 240 generates label information including a label position, similarly to the label generation unit 140 according to the first example embodiment (step S240).

A detailed example of the label generation unit 240 will be described.

### (Label Generation Unit 240)

The label generation unit 240 determines a label size of a label to be assigned to the assignment target, based on the three-dimensional information. That is, the label size is determined based on the three-dimensional information.

The label generation unit 240 generates label information including, for example, a label position specified by a position specifying unit 130 and the determined label size. The label information generated by the label generation unit 240 may further include an assignment target ID, a type of the assignment target, and the like, similarly to the label information described in the first example embodiment.

For example, the label generation unit 240 segments a three-dimensional area indicating an object for each object included in the three-dimensional information. For example, the label generation unit 240 may segment a three-dimensional area for each object included in the three-dimensional information, using a trained segmentation model that segments an area included in the three-dimensional information (a point cloud, a voxel, and the like) for each object included in the three-dimensional information. In response to an input of the three-dimensional information, the segmentation model outputs segment information obtained by segmenting a three-dimensional area indicating an object, for each object included in the input three-dimensional information.

The segment information is, for example, information indicating a three-dimensional area occupied by an object. For example, in a case where the three-dimensional area is point cloud data, the segment information includes information for identifying a point cloud included in the three-dimensional area occupied by the object, for each object included in the three-dimensional information. For example, in a case where the three-dimensional area is voxel data, the segment information includes information for identifying a voxel included in the three-dimensional area occupied by the object, for each object included in the three-dimensional information.

The method for segmenting a three-dimensional area indicating an object for each object included in the three-dimensional information is not limited to the methods exemplified here, and a known technique may be applied. For example, an approach of clustering the point clouds by using trained artificial intelligence (AI) or on a rule basis, or the like may be applied. Clustering may be performed on a three-dimensional area and point clouds around the three-dimensional area by using AI, a rule-based approach, or the like, and the point cloud of the cluster determined based on the points included in the three-dimensional area may be treated as the segment of the object of the three-dimensional area. The rule-based approach is, for example, density-based clustering such as density-based spatial clustering of applications with noise (DBSCAN), but is not limited thereto.

For example, the label generation unit 240 determines the label size, based on the segment information on the object that is an assignment target. In a case where the shape of the label is a rectangular parallelepiped, the label generation unit 240 may determine the label size, based on the size of the rectangular parallelepiped in which the three-dimensional area indicated by the segment information is inscribed. For example, the label generation unit 240 may determine the label size including the height, depth, and width of the rectangular parallelepiped in which the three-dimensional area indicated by the segment information is inscribed.

### (Operation and Effect)

As described above, according to the present example embodiment, the label size is determined based on the three-dimensional information.

As a result, a label having a size according to the dimensions of the assignment target can be assigned. Therefore, a label having appropriate dimensions according to an object included in the three-dimensional information can be assigned to the object.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other example embodiments.

In the plurality of flowcharts used in the above description, a plurality of steps (processes) is described in order, but the execution order of the steps executed in each example embodiment is not limited to the described order. In each example embodiment, the order of the illustrated steps can be changed as long as nothing interferes in terms of content.

Some or all of the example embodiments described above may also be described as the following Supplementary Notes, but are not limited to the following.

1.

An information processing device including:

a target selection means for selecting a representative part of an assignment target to which a label is to be assigned, from a captured image obtained by imaging a target area;

a reference plane specifying means for specifying a position of a reference plane in the target area, based on three-dimensional information obtained by observing the target area;

a label position specifying means for specifying a label position indicating a three-dimensional position of the label to be assigned to the assignment target, based on a position obtained by projecting the representative part onto the reference plane; and

a label generation means for generating label information including the label position.

2.

The information processing device according to 1., in which

the reference plane is a road surface of a road, and

the position obtained by projecting the representative part onto the reference plane is an intersection of a straight line three-dimensionally representing a light ray for capturing a pixel relevant to the representative part in the captured image, and the road surface.

3.

The information processing device according to 2., in which

the position obtained by projecting the representative part onto the reference plane is calculated using at least one of a calibration parameter for calibrating the captured image and the three-dimensional information, an imaging parameter that is an internal parameter of an imaging device that captures the captured image, and a three-dimensional observation parameter that is an internal parameter of a three-dimensional observation device that observes the three-dimensional information.

4.

The information processing device according to any one of 1. to 3., in which

the label information further includes a label size indicating a size of a three-dimensional area to which the label is to be assigned.

5.

The information processing device according to 4., in which

the label size is predefined according to a type of the assignment target.

6.

The information processing device according to 4., in which

the label size is determined based on the three-dimensional information.

7.

The information processing device according to any one of 1. to 6., in which

the target selection means estimates a position and a type of an object included in the captured image, and selects the estimated object as the assignment target.

8.

An information processing system including:

the information processing device according to any one of 1. to 7.;

an imaging device that captures the captured image of the target area; and

a three-dimensional observation device that observes the target area to acquire the three-dimensional information.

9.

An information processing method including:

by one or more computers,

selecting a representative part of an assignment target to which a label is to be assigned, from a captured image obtained by imaging a target area;

specifying a position of a reference plane in the target area, based on three-dimensional information obtained by observing the target area;

specifying a label position indicating a three-dimensional position of the label to be assigned to the assignment target, based on a position obtained by projecting the representative part onto the reference plane; and

generating label information including the label position.

10.

The information processing method according to 9., in which

the reference plane is a road surface of a road, and

the position obtained by projecting the representative part onto the reference plane is an intersection of a straight line three-dimensionally representing a light ray for capturing a pixel relevant to the representative part in the captured image, and the road surface.

11.

The information processing method according to 10., further including

calculating the position obtained by projecting the representative part onto the reference plane, using at least one of a calibration parameter for calibrating the captured image and the three-dimensional information, an imaging parameter that is an internal parameter of an imaging device that captures the captured image, and a three-dimensional observation parameter that is an internal parameter of a three-dimensional observation device that observes the three-dimensional information.

12.

The information processing method according to any one of 9. to 11., in which

the label information further includes a label size indicating a size of a three-dimensional area to which the label is to be assigned.

13.

The information processing method according to 12., in which

the label size is predefined according to a type of the assignment target.

14.

The information processing method according to 12., further including

determining the label size, based on the three-dimensional information.

15.

The information processing method according to any one of 9. to 14., in which

the selecting the representative part of the assignment target includes estimating a position and a type of an object included in the captured image, and selecting the estimated object as the assignment target.

16.

A program for causing one or more computers to execute:

selecting a representative part of an assignment target to which a label is to be assigned, from a captured image obtained by imaging a target area;

specifying a position of a reference plane in the target area, based on three-dimensional information obtained by observing the target area;

specifying a label position indicating a three-dimensional position of the label to be assigned to the assignment target, based on a position obtained by projecting the representative part onto the reference plane; and

generating label information including the label position.

17.

The program according to 16., in which

the reference plane is a road surface of a road, and

the position obtained by projecting the representative part onto the reference plane is an intersection of a straight line three-dimensionally representing a light ray for capturing a pixel relevant to the representative part in the captured image, and the road surface.

18.

The program according to 17., in which

the position obtained by projecting the representative part onto the reference plane is calculated using at least one of a calibration parameter for calibrating the captured image and the three-dimensional information, an imaging parameter that is an internal parameter of an imaging device that captures the captured image, and a three-dimensional observation parameter that is an internal parameter of a three-dimensional observation device that observes the three-dimensional information.

19.

The program according to any one of 16. to 18., in which

the label information further includes a label size indicating a size of a three-dimensional area to which the label is to be assigned.

20.

The program according to 19., in which

the label size is predefined according to a type of the assignment target.

21.

The program according to 19., in which

the label size is determined based on the three-dimensional information.

22.

The program according to any one of 16. to 21., in which

the selecting the representative part of the assignment target includes estimating a position and a type of an object included in the captured image, and selecting the estimated object as the assignment target.

23.

A recording medium having recorded thereon the program according to any one of 16. to 22.

1. An information processing apparatus comprising:
a memory configured to store instructions; and
a processor configured to execute the instructions to:
select a representative part of an assignment target to which a label is to be assigned, from a captured image obtained by imaging a target area;
specify a position of a reference plane in the target area, based on three-dimensional information obtained by observing the target area;
specify a label position indicating a three-dimensional position of the label to be assigned to the assignment target, based on a position obtained by projecting the representative part onto the reference plane; and
generate label information including the label position.

2. The information processing apparatus according to claim 1, wherein
the reference plane is a road surface of a road, and
the position obtained by projecting the representative part onto the reference plane is an intersection of a straight line three-dimensionally representing a light ray for capturing a pixel relevant to the representative part in the captured image, and the road surface.

3. The information processing apparatus according to claim 2, wherein
the position obtained by projecting the representative part onto the reference plane is calculated using at least one of a calibration parameter for calibrating the captured image and the three-dimensional information, an imaging parameter that is an internal parameter of an imaging device that captures the captured image, and a three-dimensional observation parameter that is an internal parameter of a three-dimensional observation device that observes the three-dimensional information.

4. The information processing apparatus according to claim 1, wherein
the label information further includes a label size indicating a size of a three-dimensional area to which the label is to be assigned.

5. The information processing apparatus according to claim 4, wherein
the label size is predefined according to a type of the assignment target.

6. The information processing apparatus according to claim 4, wherein
the label size is determined based on the three-dimensional information.

7. The information processing apparatus according to claim 1, wherein
selecting the representative part of an assignment target includes estimating a position and a type of an object included in the captured image, and selecting the estimated object as the assignment target.

8. An information processing system comprising:
the information processing apparatus according to claim 1;
an imaging device that captures the captured image of the target area; and
a three-dimensional observation apparatus that observes the target area to acquire the three-dimensional information.

9. An information processing method comprising:
by one or more computers,
selecting a representative part of an assignment target to which a label is to be assigned, from a captured image obtained by imaging a target area;
specifying a position of a reference plane in the target area, based on three-dimensional information obtained by observing the target area;
specifying a label position indicating a three-dimensional position of the label to be assigned to the assignment target, based on a position obtained by projecting the representative part onto the reference plane; and
generating label information including the label position.

10. A non-transitory computer readable medium storing a program for causing one or more computers to execute:
selecting a representative part of an assignment target to which a label is to be assigned, from a captured image obtained by imaging a target area;
specifying a position of a reference plane in the target area, based on three-dimensional information obtained by observing the target area;
specifying a label position indicating a three-dimensional position of the label to be assigned to the assignment target, based on a position obtained by projecting the representative part onto the reference plane; and
generating label information including the label position.
